(19) United States
(12) Patent Application Publication
(10) Pub. No.: US 2020/0018433 A1
(43) Pub. Date: Jan. 16, 2020

(54) CONNECTOR ARRANGEMENT FOR MEDIA PIPELINES, AND METHOD FOR CONNECTING MEDIA PIPELINES

(71) Applicant: VOSS AUTOMOTIVE GMBH, Wipperfürth (DE)

(72) Inventors: Christian ZWILLUS, Bergneustadt (DE); Michael BROMBACH, Lindlar (DE); Adrian KLEHR, Neuenrade (DE); Reiner MITTERER, Wipperfürth (DE)

(21) Appl. No.: 16/335,318

(22) PCT Filed: Sep. 21, 2017
(86) PCT No.: PCT/EP2017/073941

§ 371 Date: Mar. 21, 2019

(30) Foreign Application Priority Data
Sep. 21, 2016 (DE) 10 2016 117 830.6

(51) Int. Cl. F16L 31/02; F16L 41/02

(52) U.S. Cl. CPC F16L 31/02; F16L 41/02

(57) ABSTRACT

A plug connector arrangement for media lines including a connecting body and a lug component. The connecting body features a fluid channel and at least one receiving opening for at least partial accommodating of the lug component in communication with the fluid channel. The connecting body and the lug component being connected to each other by a connecting element that establishes a first positive-locking snap-in connection with the connecting body and a second positive-locking snap-in connection with the lug component. Also provided is a method for connecting media lines for production of such a plug connector arrangement.

The invention relates to a plug connector arrangement for media lines according to the preamble of claim 1, featuring at least one connecting body and at least one lug component, wherein the connecting body features at least one receiving opening for at least partial accommodating of the lug component and a fluid channel. Furthermore, the invention relates to a method for connecting of media lines.

The term “media line” is understood basically to mean line connections for any particular flowing and/or compressed media, such as gases and liquids. Basically media lines are tube or hose lines and also their joining and connecting elements which are part of a system for conducting of a medium.

A plurality of plug connector arrangements are known in the prior art for media lines and also methods for connecting of media lines. In particular, detachable connections, especially screw connections, are frequently used, in which a sealing tension is used for connecting of two segments of a media line, for example, by means of a cap nut and a corresponding threading.

In particular for media lines with enhanced safety requirements, an additional expense is incurred in that firstly it must be assured that a sufficient assembly force is applied, and secondly that the screw connection is secured, for example, against unintentional opening.

Therefore the present invention is based on the problem of specifying a plug connector arrangement and also a method for connecting of media lines, in which a sufficient assembly force is assured and at the same time, the assurance against unintentional loosening of the connection is increased.

According to the invention, the stated problem is solved by a generic plug connector arrangement with the features of the characterizing part of independent claim 1. Favorable design features are presented in the dependent claims and also in the following description.

The plug connector arrangement comprises a connecting body which features a receiving opening for at least partial accommodating of the lug component. For this purpose, the lug component features in particular an accommodating counter-piece by which the lug component can be inserted into the receiving opening. The accommodating counter-piece and the receiving opening are designed as corresponding to each other. Consequently, the connecting body and the lug component can be inserted into each other in that the accommodating counter-piece is inserted into the receiving opening. The receiving opening, for example, features at least two, preferably three recesses which are arranged step-wise to each other. The recesses are areas in the receiving opening with different inside diameters. Preferably the invention provides that the receiving opening or the receiving counter-piece is designed to accommodate at least one gasket, preferably an O-ring, which makes a seal between the connecting body and the lug component. Due to the multi-step configuration of the receiving opening, the lug component is already held in the receiving opening in a tilt-secure manner.

The receiving opening is connected in particular to the fluid channel of the connecting body, so that the lug component can be brought into connection with the fluid channel of the connecting body, in particular with the medium carried therein.

When inserted into the receiving opening, the lug component is at least partially connected to the fluid channel, so that the fluid conducted in the fluid channel comes into contact with the lug component or can flow through the lug component. For example, the lug component also features a fluid channel, so that the fluid channel of the connecting body is connected to the fluid channel of the lug component when the lug component is inserted into the connecting body.

The connecting body can be, for example, an arc of any particular angle, a T-piece or another structural element of a media line. The lug component, for example, can be a sensor, a barbed profile or another line component of a media line, in particular to an arc, a T-piece or a hose line. The connecting body and the lug component are each designed of plastic or of metal, depending on the particular use.

Preferably the lug component is designed as a sensor, in particular with a sensor housing. For example, the sensor housing features at least one sensor chamber, wherein one sensor channel is designed between the fluid channel and sensor chamber. The sensor function is implemented in the sensor channel. Preferably the sensor channel is sealed between the fluid channel and sensor chamber by a sensor element, for example, a membrane, a glass plate and/or an optical element.

The connecting body and the lug component are connected together in that the lug component initially is introduced, at least in part, into the receiving opening of the connecting body. The actual connection is implemented by the connecting element, which forms a positive-locking snap-in connection both with the connecting body and also with the lug component. To do so, the connecting element is pressed onto the lug component in a first pressing direction, wherein the connecting element and/or at least a portion of the lug component is at least partly elastically deformed and subsequently a positive-locking-permanent-snap-in of the connecting element with the lug component occurs. In this respect, “permanent” means that the connection cannot be detached under normal conditions, since the connecting element and the lug component, when a force is applied opposite the pressing direction, engage into each other in a positive-locking manner and any disconnecting is only possible with at least partial mechanical destruction.

Furthermore, the connecting element is pressed onto the connecting body in a second pressing direction, wherein the connecting element and/or at least a portion of the connecting body is at least partly elastically deformed and subsequently a positive-locking-permanent-snap-in of the connecting element with the connecting body occurs.

Thus the pressing step is simplified in that at least one slanting insertion element is formed across the entire perimeter along at least one front side of the connecting element arranged in the particular pressing direction. This slanting insertion element simplifies pushing of the connecting element onto the connecting body and/or onto the lug component. Preferably one slanting insertion element is provided on each of the opposing front sides of the connecting element.

The positive interlock between the connecting element and the connecting body and/or the lug component, respectively, prevents the connecting element from detaching opposite from the first or second pressing direction.

In particular it is provided that the connecting body and/or the lug component features at least one snap-in area, preferably a plurality of snap-in areas. Preferably the one snap-in area or the plurality of snap-in areas are elastic. For example, the connecting body features a first ring collar and the lug component features a second ring collar, wherein the connecting element during assembly is elastically deformed such that the connecting element can pass over at least partly, the first and/or the second ring collar, respectively, in order to become at least partly deformed into its initial shape behind the particular ring collar and thereby to form a positive-locking connection. It is preferable that the connecting element features at least one first snap-in surface and a second snap-in surface, wherein the first snap-in surface can snap into the first ring collar, and the second snap-in surface can snap into the second ring collar, each in a positive-locking manner. The outside perimeter, in particular the outside diameter, of the first ring collar and of the second ring collar, for this purpose is larger than the inside perimeter, in particular the inside diameter of the non-deformed part of the connecting element which snaps in behind the respective ring collar. It is preferable that the ring collar of the connecting body and/or the ring collar of the lug component is closed on the perimeter. But the invention also provides that the ring collar of the connecting body and/or the ring collar of the lug component features at least one slot, preferably at least two slots, especially to form snap-in areas.

Alternatively, the invention also provides that a positive-locking snap-in connection is formed in that the connecting body and/or the lug component features a snap-in groove, and that the connecting element features at least one snap-in lip. To establish the connection, the connecting element is elastically deformed, in particular in the region of the snap-in lip, so that the snap-in lip upon deforming of the connecting element into its initial shape penetrates at least partly into the snap-in groove. The inside perimeter of the snap-in lip, in particular the inside diameter, is thus smaller than the outside perimeter, in particular smaller than the outside diameter, at least of the region surrounding the snap-in groove in the direction of the connecting element.

The connecting element is preferably produced at least in part from a thermoplastic synthetic material, for example polyoxymethylene (POM). This will ensure the deformability of the material, while providing simultaneously good dimensional stability.

The plug connector arrangement according to the invention has the advantage over the prior art that an unintentional separation of the connection between the connecting body and the lug component is prevented. This is because a loosening of the connection is only possible through at least partial mechanical destruction of the connecting element or of the connecting body and/or of the lug component, respectively. Furthermore, due to the geometric configuration of the connecting element, a defined assembly force can be applied.

According to a first embodiment of the plug connector arrangement, the invention provides that the first snap-in connection and/or the second snap-in connection is designed as being closed around the perimeter thereof. This kind of perimeter sealing of the snap-in connection means that the regions of the connecting element and/or of the connecting body and/or of the lug component forming the snap-in connection do not feature any slots, recesses or similar structures, which allow a flexible movement of the components and a subsequent snap-in of the regions during the snap-in process.

A snap-in connection closed around the perimeter is formed in that the regions of the components involved in the snap-in connection are elastically deformed—at least temporarily; that is, they are in particular compressed or elongated. In particular, a snap-in connection closed along the perimeter is formed in that the connecting element is elastically deformed, in particular due to elastic deformation its perimeter is at least temporarily extended. Due to the elastic deformation, in particular elastic extension of its perimeter, the connecting element can be brought onto the connecting body and/or the lug component, and then subsequently can return at least in part to its initial shape and thereby can be joined in a positive-locking manner to the connecting body and/or to the lug component. Preferably the connecting element is pressed onto the connecting body and the lug component.

With regard to the snap-in connection closed along the perimeter, this element is a positive-locking connection formed along the entire perimeter. The connecting element securely holds the lug component to the connecting body. Any loosening of the perimeter-sealed snap-in connection between the connecting element and the connecting body or the connecting element and the lug component is only possible through mechanical destruction of the connecting element. Consequently the snap-in connection closed around the perimeter is a permanent connection, wherein this means that the connection can only be disconnected by means of at least partial destruction. To establish the connection the connecting element is elastically deformed and brought onto the lug component, in particular is pressed thereon, such that a snap-in connection is formed which is closed around the perimeter. Furthermore, the connecting element is subsequently elastically deformed and brought onto the lug component, in particular is pressed thereon, such that likewise a snap-in connection is produced which is closed around the perimeter.

An additional embodiment of the plug connector arrangement provides that the connecting element features at least one slot, in particular a slot oriented parallel to the longitudinal axis of the connecting element, preferably that the connecting element features a plurality of slots. The slot or the slots are oriented preferably parallel to the longitudinal axis of the connecting element. If a plurality of slots is used, then they are distributed, for example, uniformly or irregularly across the perimeter of the connecting element. Preferably between two and twenty slots are provided, which are distributed along the perimeter. The invention also provides that along the longitudinal axis of the connecting element, viewed in a first edge region there is a plurality of slots distributed along the perimeter, and that in a second edge region arranged oppositely in the longitudinal direction there is a second plurality of slots distributed along the perimeter.

An additional embodiment of the invention provides that the slot extends from a first edge region of the connecting element—viewed in the longitudinal direction—or that the slot is arranged between two edge regions, that is, between a first edge region and a second edge region. Consequently, the slot is designed as open on one side or is arranged such that one bar remains each in the first edge region and/or in the second edge region of the connecting element—viewed along the longitudinal axis. The bar remaining in the edge region means that the positive-locking snap-in connection is closed along the perimeter, even though the connecting element features at least one slot along at least a portion of its height.

In the case of a plurality of slots, there are preferably between 2 to 20 slots in each edge region and distributed along the perimeter. The slots have a length that extends across about one-third of the height of the connecting element. When slots are arranged in both edge regions, the slots extend across two-thirds of the height of the slots, and about one-third of the height is not covered with slots. For example, the slot or slots, respectively, extends or extend through the snap-in surfaces of the connecting element.

According to an additional embodiment of the plug connector arrangement, the invention provides that the connecting element features a first snap-in section and a second snap-in section, wherein preferably the first snap-in section snaps-in with the connecting body and the second snap-in section snaps in with the lug component. In particular, the first snap-in section and/or the second snap-in section is designed as a snap-in setback. The connecting element with the first snap-in section and/or with the second snap-in section is brought onto the connecting body and/or onto the lug component such that a positive-locking connection is produced between the first snap-in section and/or the second snap-in section and a region at the connecting body and/or the lug component, respectively.

In the exemplary embodiments in which a slot or slots are provided in the connecting element, the invention also provides that the slot or the slots each proceeding from the first or second edge region extend into the first snap-in section and/or into the second snap-in section, preferably each roughly along one-third of the height of the connecting element.

Preferably a first ring collar is formed on the connecting body and/or a second ring collar is formed on the lug component, so that the first snap-in section can snap in with the first ring collar of the connecting body and the second snap-in section can snap in with the second ring collar of the lug component to form a positive-lock. Preferably a first snap-in surface of the connecting element snaps in with the first ring collar and a second snap-in surface of the connecting element snaps in with the second ring collar. Both the first snap-in section and also the second snap-in section are closed in particular along the perimeter. Furthermore, the first ring collar and the second ring collar are closed along the perimeter.

The first snap-in section and the second snap-in section are designed preferably as a cohesive snap-in setback with two opposing snap-in surfaces, or alternatively as two separate snap-in setbacks.

According to an additional embodiment of the plug connector arrangement, the invention provides that an inside perimeter of the connecting element is designed as a circular ring shape. It is particularly preferred that the connecting element is designed overall as a circular ring shape. Due to the circular ring shape, in particular due to the rotation-symmetrical configuration of the inside perimeter of the connecting element, in particular of the first snap-in section and of the second snap-in section, a favorable assembly of the connecting element is possible. In addition, after the assembly, that is, after the establishment of the connection by means of the connecting element, a rotation of the lug component relative to the connecting body is possible—depending on the particular embodiment.

It is particularly preferred that the connecting element is designed overall as a circular ring shape. For example, the connecting element features a circular ring shaped base body which features at least one, in particular two snap-in sections. The snap-in sections are designed preferably as snap-in setback or as snap-in setbacks, that is, as regions of expanded inside diameter. Due to the ring-shaped configuration a uniformly elastic deformation is ensured while the connecting element is brought up onto the connecting body and/or onto the lug component. In particular the invention also provides that the connecting element, in particular the base body, features at least one region along its perimeter and/or along its axial extension, where this region is composed of a material different from the remainder of the base body or the remainder of the connecting element. For example, it features a greater elasticity. Thus for example, a locally different deformability can be achieved which promotes the assembly process. Preferably a plurality of regions of different material is provided along the perimeter and/or in the axial extension.

According to another embodiment, the plug connector arrangement is improved in that the connecting element features an elastic compensating element, and that the compensating element is arranged in an axial direction, at least partly between the connecting body and the lug component. Consequently, the compensating element is arranged at the connecting element such that the compensating element in the assembled state is disposed at least in part between the connecting body and the lug component, for example, at a recess of the connecting body. The invention provides that the compensating element is connected to the connecting element by a positive lock and/or is firmly bonded and/or is force fitted. Preferably the invention provides that the compensating element is formed, preferably molded or pressed onto the connecting element, in particular onto a base body of the connecting element. Furthermore, the invention also provides that the connecting element features at least one snap-in recess for the compensating element, and the compensating element itself, or a part of the compensating element engages into the snap-in recess to form a positive-locking connection.

According to another embodiment of the invention, the compensating element features a smaller modulus of elasticity than a base body of the connecting element, in particular the modulus of elasticity of the base body of the connecting element, in particular the connecting element with the exception of the compensating element, is in the range between 1 GPa and 10 GPa and the modulus of elasticity of the compensating element is in the range between 0.0004 GPa and 0.1 GPa. The compensating element is produced from a different material than the remainder of the connecting element. In particular, the compensating element is made of a material that is more elastic than the material of the remainder of the connecting element.

Favorable materials for the compensating element have proven to be elastomers, especially thermoplastic elastomers. Particularly preferred are styrene block copolymers, especially styrene-ethylene-butylene-styrene copolymers (SEBS). It is advantageous that the connecting element is a two-component element made of POM—base body and a styrene block copolymer compensating element.

The connecting element features in particular an elastic deformability of between 1% and 15%. The material of the connecting element is selected preferably so that the elastic deformation under applied operating pressure is between 1% and 2%. When producing the snap-in connections, an elastic deformation of the connecting element takes place preferably in the range between 6% and 7%, especially of 6.7%.

During the assembly in particular, the compensating element is compressed at least in part, preferably compressed by up to 50%.

The compensating element is provided in particular to compensate for tolerances between the connecting body and the lug component. Simultaneously an axial pre-tensioning is achieved by the compensating element which acts on the connecting element.

Preferably the invention provides that the connecting element, in particular the compensating element is provided at least in part with a coating, preferably with a coating made of polytetrafluoroethylene (PTFE). The coating, for example, ensures that the lug component can rotate relative to the connecting body in the region of the first snap-in connection and/or of the second snap-in connection.

In particular in order to create a pre-tension in the axial direction between the connecting body and the lug component, according to another embodiment of the plug connector arrangement, the invention provides that the compensating element features a polygonal, in particular a trapezoidal, circular or oval cross section in each cross-sectional level which includes a longitudinal axis L of the connecting element or that the compensating element features a cross section with at least one concave or convex region. Each level that fully includes the longitudinal axis of the connecting element and that intersects the compensating element acts as a cut plane for the cross section. The compensating element is in particular rotation-symmetrical.

A first variant of a compensating element has a rectangular cross section, so that the compensating element features a constant thickness in the region between the connecting body and the lug component. However, the invention provides preferably that the compensating element features a trapezoidal cross section, especially a trapezoidal cross section tapering in the direction of the longitudinal axis of the connecting element. Due to the trapezoidal cross section, the compensating element acts like a wedge between the connecting body and the lug component and thus produces a favorable axial pre-tension.

Furthermore, the invention also provides that the compensating element features a cross section with at least one convex or concave region. Preferably the cross section features at least two concave regions. In particular the invention provides that the compensating element features at least one first contact surface and at least one second contact surface. The contact surfaces act in particular to support the connecting body and the lug component when the compensating element is located between them. For example, the first contact surface and the second contact surface are designed as convex or concave, or feature at least one or a plurality of convex and/or concave regions.

Furthermore, according to an embodiment, the invention provides that the compensating element is arranged offset in the axial direction of the connecting element. Due to this kind of arrangement of the compensating element, an assembly direction of the connecting element can be specified, for example, so that the connecting element can only be assembled in one alignment, thus for example only in a certain alignment on the connecting body or only in a certain alignment on the lug component. Consequently, a preferred press-in direction is defined by the shape of the connecting element. Furthermore, with this kind of embodiment there is an advantage if initially the shorter section of the connecting element is pressed onto the connecting body or the lug component, and thereafter the longer section of the connecting element is pressed onto the remaining component, that is, onto the connecting body or the lug component. The expansion occurring in the region of the longer section has a lesser effect on the shorter section than would occur for a section of equal length.

In order to loosen the connection between connecting body and lug component, according to an additional embodiment, the invention provides that the connecting element, in particular the base body, features at least one set fracture point for irreversible radial or axial separating, preferably that the connecting element features at least two set fracture points. The term “set fracture point” also includes set fracture regions which feature a larger size, for example, which are designed to encompass the full circumference of the connecting element.

The set fracture point for radial separation is designed such that the connecting element will tear apart at the set fracture point, that at least partly the perimeter is expanded and thus a loosening of the lug component from the connecting body is possible. The set fracture point for axial separation is provided such that a division of the connecting element takes place in the axial direction, so for example, the connecting element is separated into two separate rings. Preferably a combination of radial and axial set fracture points and/or both an axial set fracture point and also a radial set fracture point are used, so that according to the choice of the user, both an axial separation and also a radial separation is possible.

Furthermore, the invention provides that the set fracture point for axial separation is arranged centrally, or alternatively is arranged axially offset in relation to the longitudinal axis of the connecting element—along the longitudinal axis. Due to a central arrangement of the set fracture point, the compensating element remains either at the connecting body or at the lug component, depending on any unforeseeable material damage. Due to an offset arrangement of the set fracture point, the separating of the connecting element can be specifically controlled, namely it can be determined whether the compensating element remains on the connecting body or on the lug component, for example, or breaks apart above or below the compensating element. The connection between connecting body and lug component is always broken apart by an axial or also by a radial separating.

According to an additional favorable embodiment of the invention, it turns out to be particularly favorable that the set fracture point comprises at least one engagement groove for a tool on the outside perimeter of the connecting element, in particular of the base body, especially that at least one groove collar is provided on the engagement groove.

Preferably the radial set fracture point is thus designed as an engagement groove surrounding the perimeter of the connecting element. Additionally or alternatively, a set fracture point is provided as a radial set fracture point arranged parallel to the longitudinal direction of the connecting element. It is particularly preferred to supply both an engagement groove extending across the entire perimeter for axial separating, and also an engagement groove in at least one section for radial separating.

In addition, the invention provides preferably that at least one groove collar, preferably two groove collars, thus one groove collar on each side of the engagement groove, are provided on the engagement groove. The groove collar represents an elevation, preferably with a rectangular cross section, on at least one groove flank, so that the potential leverage with a tool is improved. Preferably a groove collar is provided on each groove flank, so that the depth of the groove is increased by the groove collar forming the elevation, and thus the engagement by a levering tool is simplified.

Particularly advantageous is a connecting element with an engagement groove extending over the entire circumference, which has a radial engagement groove on at least one point which extends in a T-shape away from the circumferentially extending engagement groove. Likewise the groove collars are designed as T-shaped on both sides of the engagement groove in the region of the transition of the full circumference engagement groove to the radially extending engagement groove. Depending on the user's choice, the connecting element can be separated in the region of the circumferential extending engagement groove or in the region of the axially extending engagement groove. Preferably the axially extending engagement groove is designed such that it extends only on one side of the circumferentially extending engagement groove, thus for example only onto half the height of the connecting element. Thus in this manner the axial engagement groove can be separated such that the connecting element is detached only from the component, thus only from the connecting body or the lug component, in the direction of which the engagement groove is oriented.

In order to define the assembly direction or to specify a relative rotation between the lug component and the connecting body, for example with an angled separation or a sensor, according to an additional embodiment, the invention provides that the connecting element features along its inner perimeter at least one snap-in recess and/or at least one snap-in protrusion for establishing an angle of rotation between connecting element and lug component, and/or between connecting element and/or connecting body. With the snap-in protrusion or the snap-in recess which cooperates with a corresponding counter-piece, either solely one individual, predetermined assembly angle can be specified, namely in that only one individual snap-in position is allowed. Alternatively, by provision of regularly arranged, cooperating snap-in recesses or snap-in protrusions, any particular setting within specific angular stages can be obtained.

An additional favorable embodiment of the plug connector arrangement provides that the connecting element features at least one first snap-in surface and at least one second snap-in surface, and that at least one positioning means is provided on the first snap-in surface and/or at the second snap-in surface for establishing an angle of rotation between connecting element and lug component and/or between connecting element and/or connecting body. The positioning means is designed, for example, in that the first snap-in surface and/or the second snap-in surface is designed as at least partly corrugation-like in the perimeter direction, and that on the lug component and/or the connecting body, a corresponding opposing contour is provided, so that during the assembly, a rotation angle can be defined between the connecting element and the lug component and/or the connecting body.

For example, in the first snap-in surface and/or in the second snap-in surface there are trapezoidal protrusions arranged at regular distances to each other. In particular, regularly arranged, trapezoidal setbacks are formed as opposing contours in the ring collar of the lug component and/or in the ring collar of the connecting body. The trapezoidal shape has the advantage that the corresponding protrusions and setbacks can slide easily along the sloped surfaces into the snap-in position. Due to a plurality of protrusions and setbacks arranged across the perimeter of the snap-in surfaces and/or the ring collars, the corresponding angle of rotation can be adjusted with a step size that depends on the spacing of the protrusions and setbacks to each other. Preferably the first and the second snap-in surfaces are each arranged in a plane which is a normal to the longitudinal axis of the connecting means.

Consequently, the positioning means is provided to transfer torque around the longitudinal axis of the connecting element. The positioning means is designed preferably as a positive-locking engagement between the first snap-in surface and/or the second snap-in surface and the particular opposing contour on the lug component or on the connecting body.

This design embodiment has the advantage that the force transmission for the positive-locking snap-in connections occurs across the snap-in surfaces. This favorable force transmission can also be used to specify the angle between connecting element and lug component and/or connecting body, respectively.

According to one particularly favorable embodiment of the plug connector arrangement, the connecting element is held at least in part by a radial tensioning force against the connecting body and/or against the lug component, wherein the tensioning force is applied preferably to a first ring collar on the connecting body and/or to a second ring collar on the lug component. The connecting element is brought onto the connecting body and the lug component by means of elastic deformation, so that first the positive-locking, in particular circumferentially enclosed snap-in connection is formed. But in addition, the invention also provides, for example, that the outside diameter of the corresponding region on the connecting body and/or on the lug component, respectively, is designed as slightly larger than the original inside diameter of the connecting element, so that the connecting element does not return entirely to its original shape after assembly, but rather rests with a radial tensioning force against both the connecting body and also against the lug component.

Preferably the first ring collar and/or the second ring collar have an excess dimension, that is, a greater outside diameter than the first snap-in section and/or the second snap-in section, respectively, of the connecting element in its relaxed, initial shape, so that the radial tensioning is formed in the region of the snap-in sections or ring collars, respectively. Viewed alternatively, the inside diameter of the first snap-in section and/or of the second snap-in section features an under-dimensioning so as to produce the tension. Preferably the over-dimensioning or the under-dimensioning, respectively, is in the range between 0.1 mm and 0.2 mm, particularly preferred is 0.15 mm. The reliability of the connection is increased by this radial pre-tensioning force.

The axial stability of the plug connector arrangement according to another embodiment of the invention is improved in that the connecting body features at least one contact surface, in particular an axially arranged contact surface, for the connecting element. The contact surface is arranged so that the connecting element with its front face or slanted insertion part directed in the direction of the connecting body rests at least in part against this contact surface when in the assembled state. Thus the contact surface prevents any additional axial movement of the connecting element in the direction of the connecting body, so that for example, the compensating element is relieved in respect to axial forces, and any damage to the compensating element is prevented. The contact surface in particular is arranged in a plane whose normals are aligned parallel to the longitudinal axis of the connecting element.

In addition, it has also proven to be advantageous that the connecting body features a retaining area for radially insertable retaining arms of an assembly tool, in particular that the retaining area features at least one retaining surface. During the assembly, a pressing force acts on the connecting element. In order that the connecting element can be pressed onto the connecting body, a counter-force must be applied, that is, the connecting body must be held. In this regard the connecting body features a retaining area which can be grasped with radially insertable retaining arms. Preferably the retaining area features a retaining surface which preferably is arranged in a plane whose normal is aligned parallel to the longitudinal axis of the connecting element. Furthermore, the retaining surface is arranged so that it is arranged as pointing away from the connecting element, so that a retaining force can be transferred from the retaining arms to the retaining surface which is directed opposite the pressing force in the second pressing direction.

The problem named in the introduction is further solved by a method for connecting of a connecting body and of a lug component of a media line, where such a method comprises the following steps:
establishing a first positive-locking snap-in connection between a connecting element and the lug component, in that the connecting element is pressed in a first pressing direction at least partly onto the lug element,
establishing a second positive-locking snap-in connection between a connecting element and the connecting body, in that the connecting element is pressed in a second pressing direction at least partly onto the connecting body, so that the lug component is connected to the connecting body by means of the connecting element.

This kind of connecting of a lug component to a connecting body has the advantage that the lug component is held reliably and with a pre-defined assembly force against the connecting body. In order to separate the connection, the connecting element must be mechanically destroyed at least in part. The first press-on direction and the second press-on direction are arranged opposite to each other.

A first embodiment of the method provides that the production of the first positive-locking snap-in connection and the production of the second positive-locking snap-in connection take place under at least partial elastic deformation of the connecting element. Preferably due to the pressing, the circumference of the connecting element expands and it can then be brought onto the connecting body or the lug component.

According to a first embodiment of the method, it has proven expedient that the pressing force for pressing the connecting element onto the connecting body and/or onto the lug component, respectively, is applied directly onto the connecting element, in particular onto a front surface of the connecting element. To do this, for example, an assembly adapter is used which spans the lug component. Furthermore, the connecting body during the assembly is held by two retaining arms, and is brought up to the connecting body radially from two sides for example.

In order that the pressing force is applied preferably only onto one front surface of the connecting element, the connecting element is exposed during assembly to only a compressive force which does not result in any damage to the connecting element. The elastic deformation takes place in that the connecting element with slanting insertion surface slides onto corresponding slanting insertion surface of the connecting body and/or of the lug component, respectively, and thus it is expanded in the radial direction.

Additional favorable refinements of the invention are characterized in the dependent claims. The invention will be explained in greater detail below based on the design embodiments depicted in the drawings. The figures show:

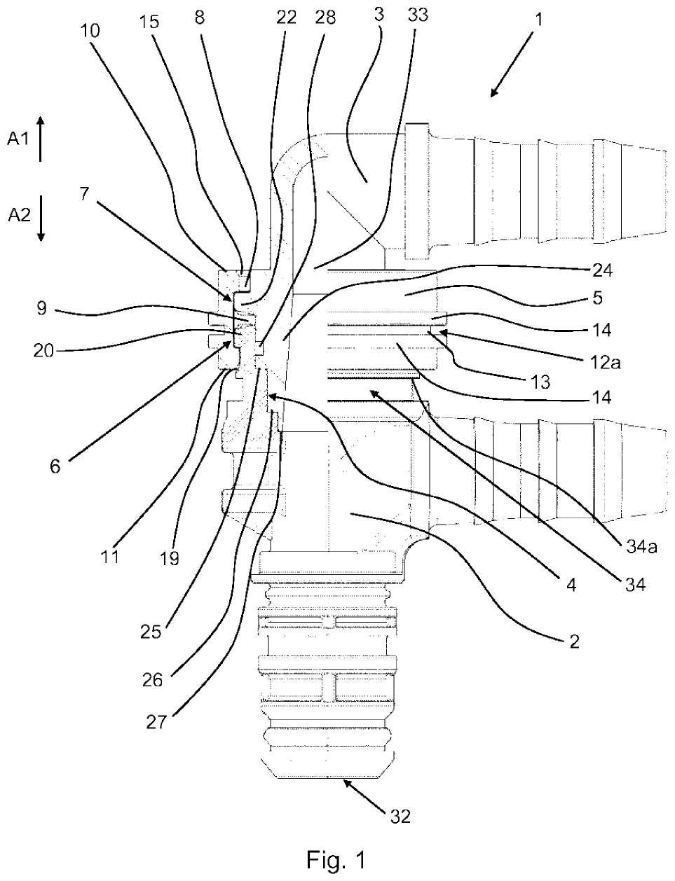

FIG. 1 One exemplary embodiment of a plug connector arrangement in partial cut-away view,

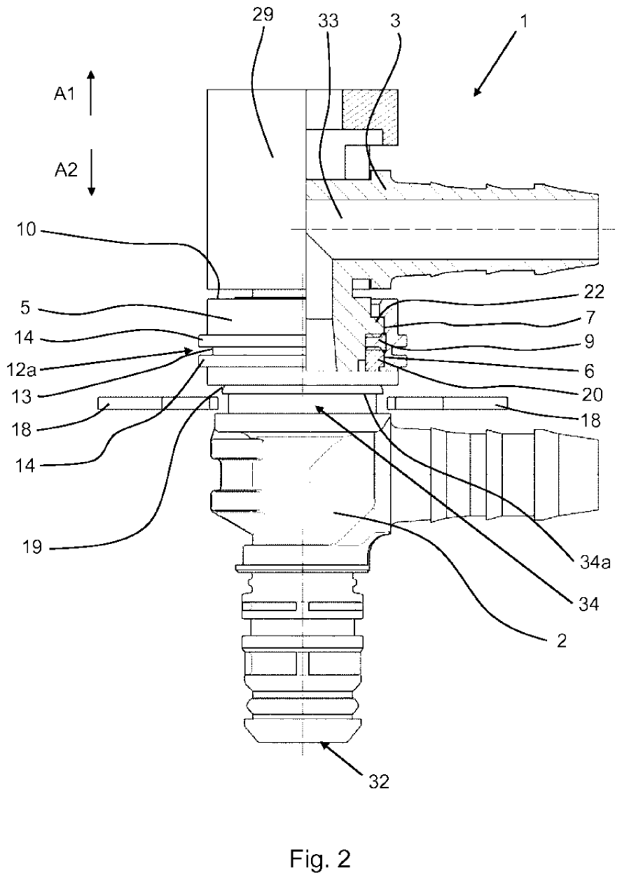

FIG. 2 One exemplary embodiment of a plug connector arrangement in partial cut-away view,

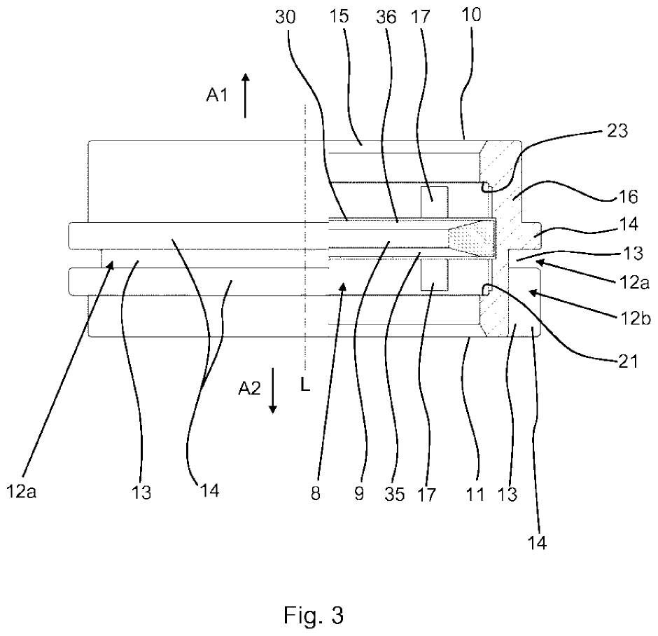

FIG. 3 One exemplary embodiment of a connecting element in partial cut-away view,

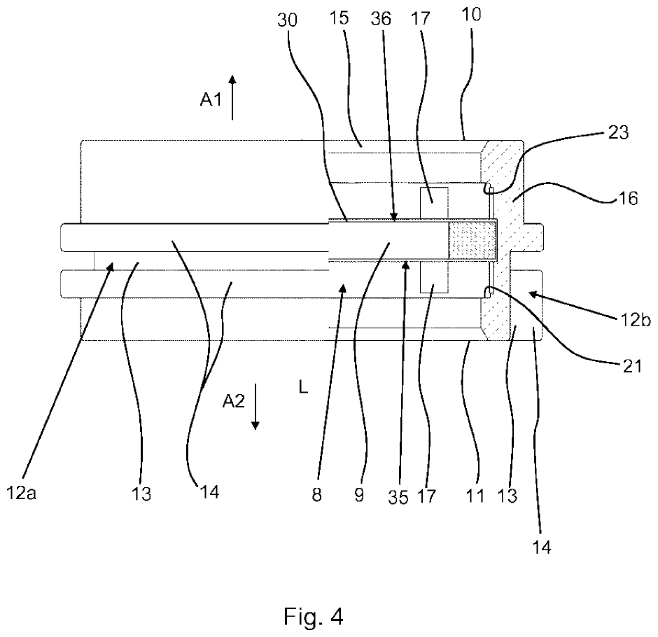

FIG. 4 One exemplary embodiment of a connecting element in partial cut-away view,

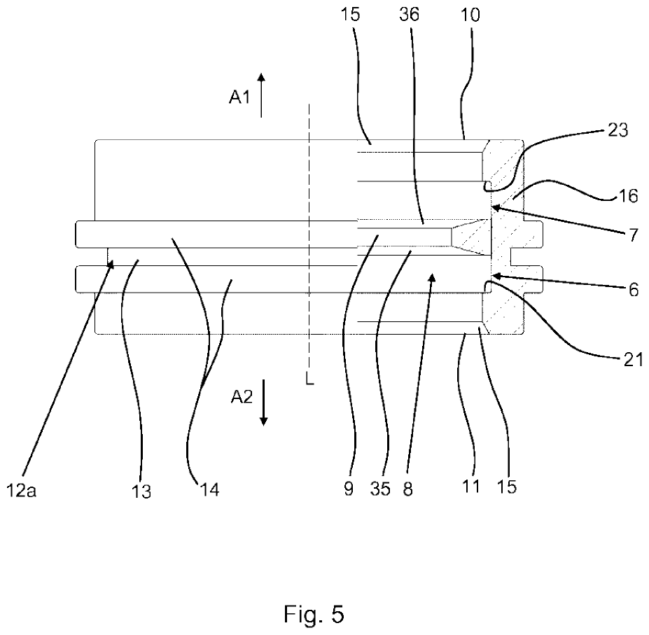

FIG. 5 One exemplary embodiment of a connecting element in partial cut-away view,

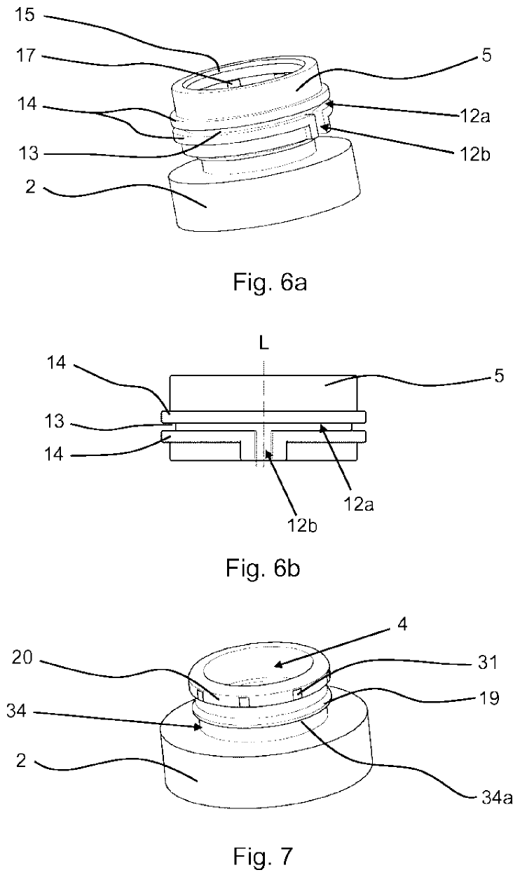

FIG. 6a An exemplary embodiment of a connecting element mounted on one side, perspective view,

FIG. 6b One exemplary embodiment of a connecting element in side view,

FIG. 7 An exemplary embodiment of a part of a connecting body, perspective view,

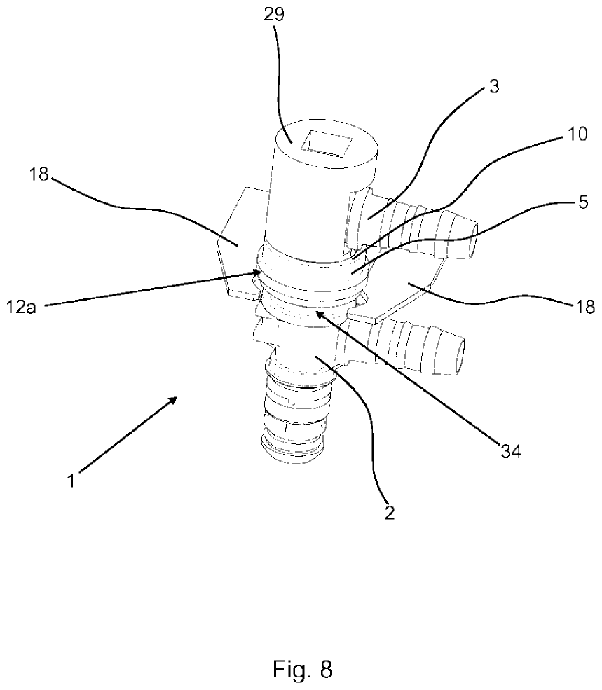

FIG. 8 The assembly of a plug connector arrangement, perspective view,

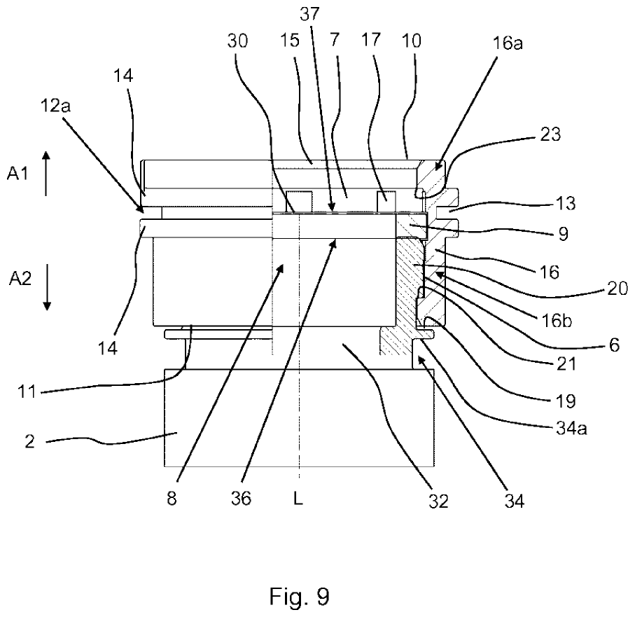

FIG. 9 An exemplary embodiment of a connecting element mounted on one side, partial cut-away view, and

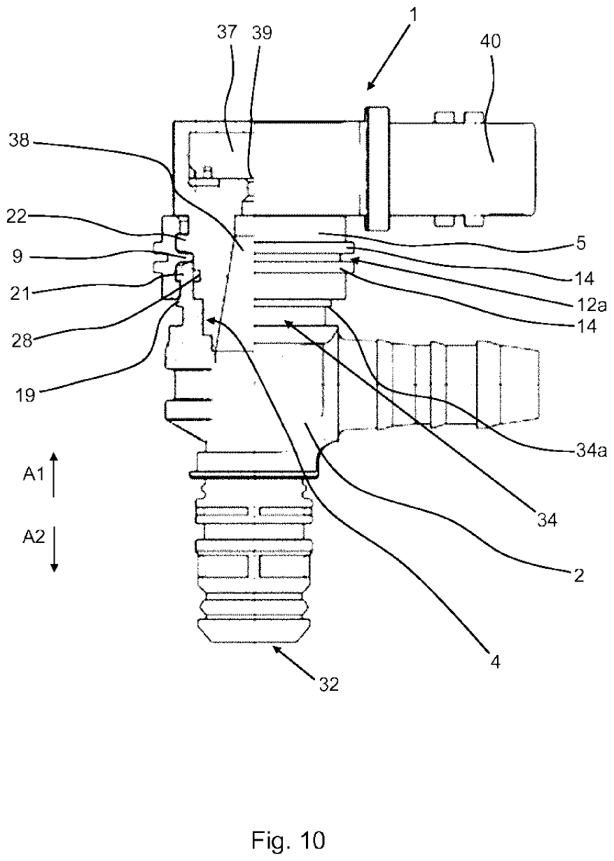

FIG. 10 One exemplary embodiment of a plug connector arrangement in partial cut-away view,

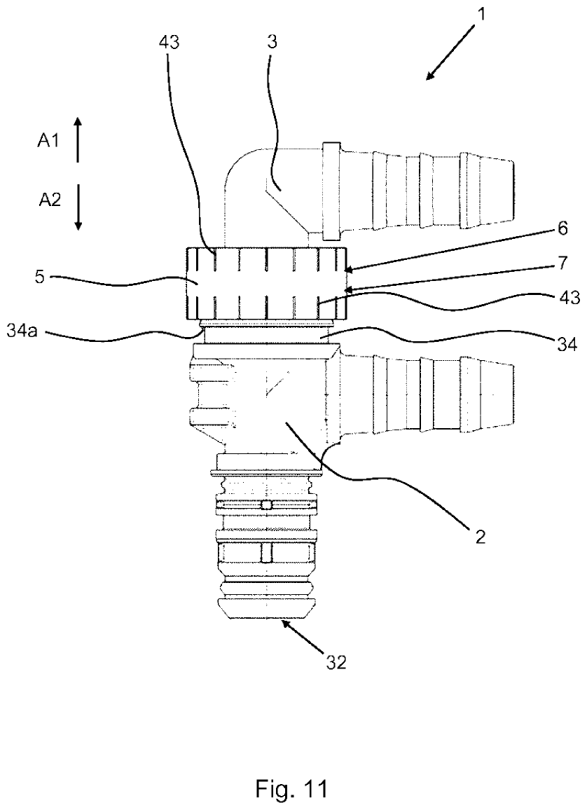

FIG. 11 One exemplary embodiment of a plug connector arrangement,

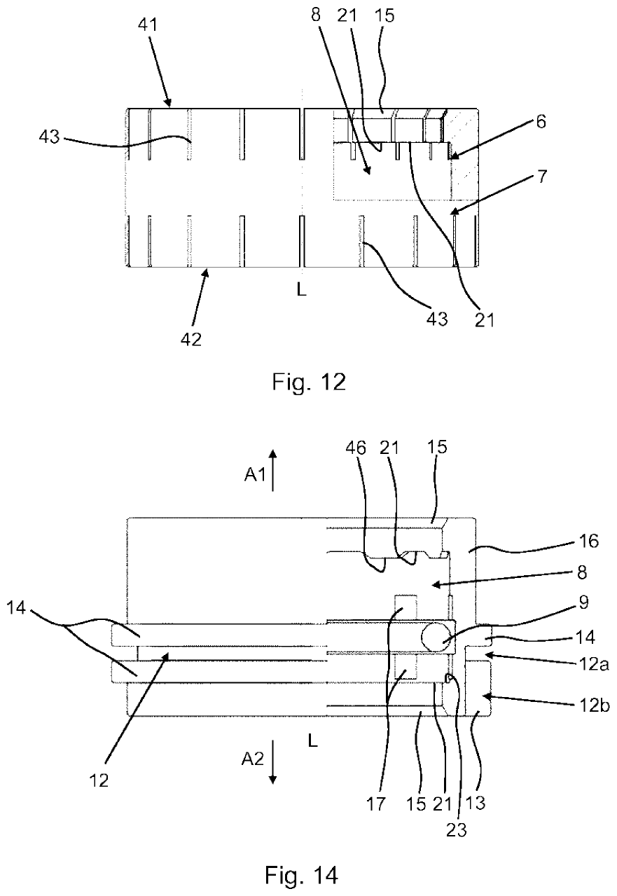

FIG. 12 One exemplary embodiment of a connecting element in partial cut-away view,

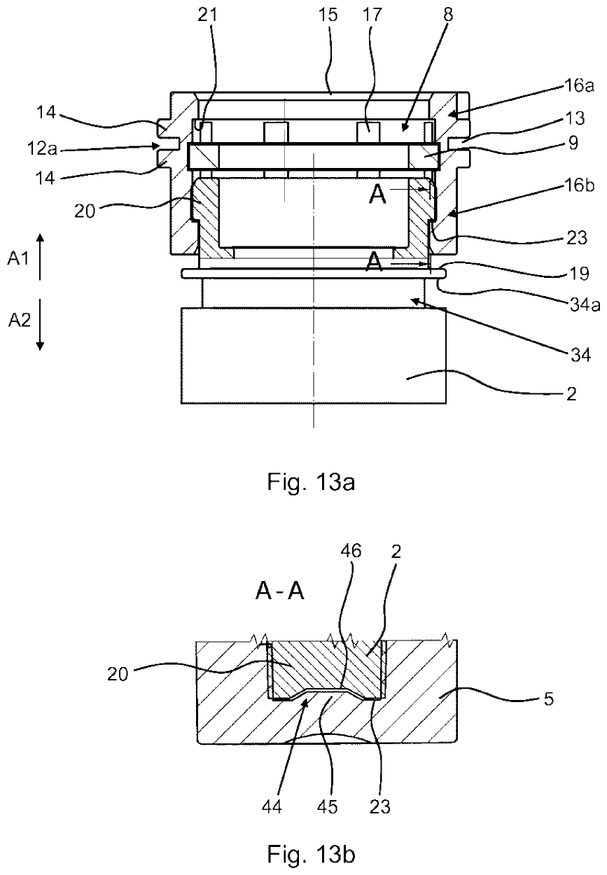

FIG. 13a An exemplary embodiment of a connecting element mounted on one side, partial cut-away view,

FIG. 13b The cut-away view according to FIG. 13a along line A-A,

FIG. 14 One exemplary embodiment of a connecting element in partial cut-away view,

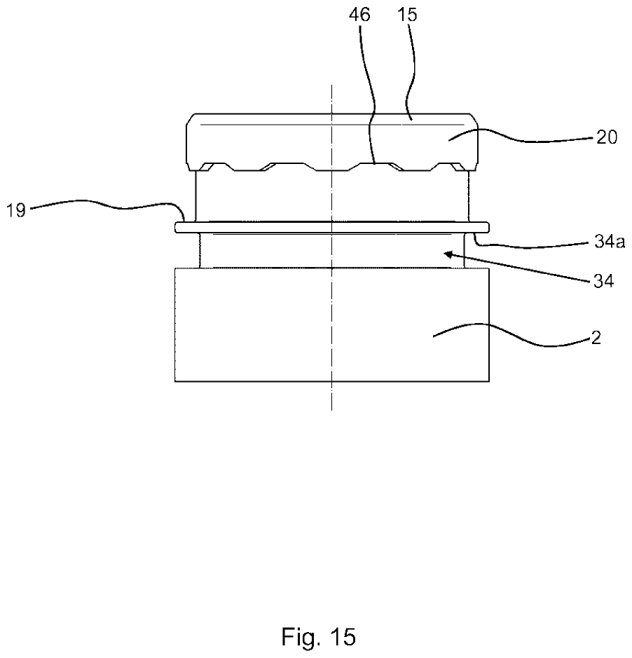

FIG. 15 One exemplary embodiment of a connecting body and

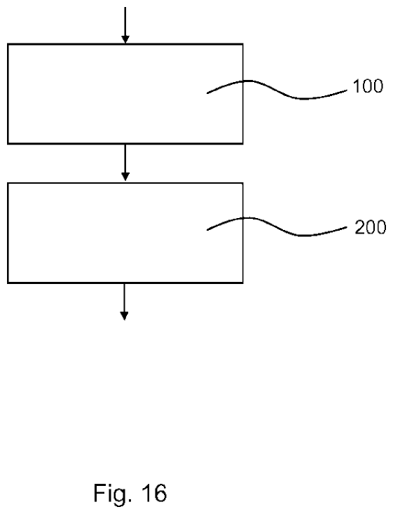

FIG. 16 A schematic flowchart of the method for connecting of media lines.

The same parts in the various figures are always denoted by the same reference symbols.

With regard to the following description it is claimed that the invention is not limited to the design examples and not to all or a plurality of features of described feature combinations, rather each individual partial feature of the/of each design example is also of importance to the subject matter of the invention, even detached from all other part features described in connection therewith, and also in combination with any other particular features of another design example.

FIG. 1 shows one exemplary embodiment of a plug connector arrangement 1 for media lines. The plug connector arrangement 1 comprises a connecting body 2, which in this exemplary embodiment is designed as a 90°-arc with mandrel, and also a lug component 3 which in this exemplary embodiment is also designed as a 90°-arc with mandrel. The lug component 3 is accommodated at least in part in a receiving opening 4 of the connecting body 2 and is held stable in its position. The connecting body 2 and the lug component 3 are connected together with a connecting element 5. The connecting element 5 features a first snap-in section 6 and a second snap-in section 7, wherein the first snap-in section 6 snaps-in with the connecting body 2 and the second snap-in section 7 snaps-in with the lug component 3, and forms a positive-locking snap-in connection that is enclosed in particular along the perimeter. The first snap-in section 6 and the second snap-in section 7 of the connecting element 5 in this exemplary embodiment are designed as snap-in setbacks.

The connecting body 2 features a fluid channel 32, which in this exemplary embodiment is connected to the lug component 3, in that the fluid channel 32 is connected to a fluid channel 33 of the lug component 3.

The connecting element 5 in this exemplary embodiment is designed on its inside circumference 8 and also overall as a circular ring shape. The connecting element 5 comprises an elastic compensating element 9 that is arranged at least in part between the connecting body 2 and the lug component 3 and causes an axial pre-tension. The compensating element 9 is produced from a different material than the remaining connecting element 5—the base body 16—and is molded onto the base body 16 of the connecting element 5 (see FIG. 3).

In this exemplary embodiment, the compensating element 9 is positioned centrally, so that it has an equal distance to the front surface 10 oriented in the direction of the lug component 3, and also to the front surface 11 oriented in the direction of the connecting body 2. Furthermore, the compensating element 9 in this exemplary embodiment features a polygonal cross section, namely a trapezoidal-shaped cross section, which is tapered in the direction of the longitudinal axis L (see FIG. 3) of the connecting element 5.

The connecting element 5 additionally features a set fracture point 12a for irreversible [sic], axial separating of the connecting element 5. The set fracture point 12a comprises an engagement groove 13 and also a grooved collar 14 on each groove flank which promotes its engagement with a tool. The engagement groove 13, and thus also the set fracture point 12a, is offset in the direction of the front surface 11 and/or in the direction of the connecting body 2, so that a separation occurs underneath the compensating element 9.

The first snap-in section 6 snaps into a first ring collar 20 of the connecting body 2, in that the first ring collar 20 rests fully against the perimeter of a snap-in surface 21 (see FIGS. 3 to 5) of the first snap-in section 6. In addition, the first ring collar 20 features an over-dimension, so that the connecting element 5 produces a radial pre-tensioning force on the connecting body 2 in the region of the first snap-in section 6. Furthermore, the second snap-in section 7 snaps into a second ring collar 22 of the lug component 3, in that the second ring collar 22 rests fully against the perimeter of a second snap-in surface 23 (see FIGS. 3 to 5). In addition, the first ring collar 22 features an over-dimension, so that the connecting element 5 produces a radial pre-tensioning force on the connecting body 3 in the region of the first snap-in section 7.

The connecting element 5 has been pressed onto the lug component 3 [sic] in a first pressing direction A1. Furthermore, the connecting element 5 is pressed onto the connecting body 2 in a second pressing direction A2.

The lug component 3 is brought at least partly with a receiving counter-piece 24 into the receiving opening 4 of the connecting body 2. The receiving opening 4 features a first recess 25, a second recess 26 and also a third recess 27, against which the receiving counter-piece 24 rests. The receiving counter-piece 24 features a sealing groove 28 which is provided for accommodating of a gasket (not depicted).

The connecting body 2 features a retaining region 34 for retaining arms 18 of an assembly tool (see FIG. 2 and FIG. 8). The retaining region 34 features in particular a retaining surface 34a against which the retaining arms 18 are braced in order to create a pressing force directed opposite to the holding force.

FIG. 2 shows one exemplary embodiment of a plug connector arrangement 1 with a connecting body 2 and a lug component 3. The plug connector arrangement 1 is designed nearly identical to the exemplary embodiment in FIG. 1, with the sole difference that the compensating element features a different cross section.

In addition, an assembly adapter 29 is depicted in FIG. 2; it at least partly extends over the lug component 3 and can apply a pressing force onto the front side 10 of the connecting element 5 in the second pressing direction A2. Furthermore, retaining arms 18 are illustrated which hold the connecting body 2 while the connecting element 5 is being pressed on. The retaining arms 18 hold the connecting body 2 such that when pressing in the second pressing direction A2, an opposing force is created which is directed toward the first pressing direction A1, that is, it is directed oppositely. The retaining arms 18 are brought radially up to the connecting body 2 and engage the connecting body 2 in a holding area 34. In particular the retaining arms 18 are braced against the retaining surface 34a. The fluid channel 32 of the connecting body 2 is connected here also with the fluid channel 33 of the lug component 3.

FIG. 3 shows one exemplary embodiment of a connecting element 5 which features a set fracture point 12a for radial separating and likewise also a set fracture point 12b for axial separating. In addition, each of the set fracture points 12a, 12b features an engagement groove 13 and a grooved collar 14. In both press-on directions A1, A2 along the longitudinal axis L, the connecting element 5 features slanting insertion surfaces 15 which simplify pressing on the connecting element 5. The compensating element 9 in this exemplary embodiment features a trapezoidal-shaped cross section, and is held in a positive-lock against the ring-shaped base body 16 in a snap-in recess 30 of the connecting element 5. A first support surface 35 and a second support surface 36 are used to support a connecting body 2 and/or to support a lug component 3 (see FIG. 1). Along its inside perimeter 8 the connecting element 5 features snap-in recesses 17 in the first snap-in section 6 and in the second snap-in section 7; these recesses provide the rotational alignment of the lug component 3 with respect to the connecting body 2. Due to the plurality of snap-in recesses 17, different positions can be adjusted.

In the exemplary embodiment according to FIG. 3, the set fracture site 12a with its engagement groove 13 and the grooved collar 14 are arranged at an offset; in this exemplary embodiment they are arranged at an offset in the direction of the front surface 11 so that a separation always occurs—according to FIG. 3—underneath the compensating element 9. This will ensure that the at least partly separated connecting element 5 remains largely on the lug component 3. This is an advantage in particular when the lug component 3 (see FIG. 1) is provided for one-time use and for example, the disconnected separated element 5 is to be disposed together with the lug component 3.

FIG. 4 shows one exemplary embodiment that is designed similarly to the exemplary embodiment according to FIG. 3. The difference is that the compensating element 9 features a rectangular cross section. The first support surface 35 and the second support surface 36 are each arranged in a plane whose normal is the longitudinal axis L of the connecting element 5. The compensating element 9 is likewise held in a positive-locking manner in a snap-in recess 30. Here too, the compensating element 9 is produced from a different material than the base body 16 of the connecting element 5—namely from a material that has a smaller modulus of elasticity.

FIG. 5 shows an exemplary embodiment of the connecting element 5 in which again the set fracture point 12a is arranged at an offset. This exemplary embodiment of a connecting element 5 features only one set fracture point 12a for axial separating. The compensating element 9 is molded onto the base body 16 and consists of a different material than the base body 16. The cross section of the first support surface 35 and of the second support surface 36 are inclined toward each other in the direction of the longitudinal axis L. For example, the base body 16 of the connecting element is produced from polyoxymethylene (POM) and the compensating element 9 is produced from a thermoplastic elastomer (TPE).

FIG. 6a shows an exemplary embodiment of a connecting element 5 in perspective view, which is brought onto an at least partially represented connecting body 2. The configuration of the radial set fracture site 12a and of the axial set fracture site 12b are clearly seen, namely that the set fracture site 12a passes into the set fracture site 12b in a T-shaped region. Likewise the engagement grooves 13 pass into the grooved collars 14. The axial set fracture site 12b with its engagement groove 13 is designed so that it extends up to the engagement groove 13 of the radial set fracture site 12a and thus a radial separating is possible only at the connecting body 2.

FIG. 6b shows one exemplary embodiment of a connecting element which corresponds to the exemplary embodiment according to FIG. 6a. The axial set fracture site 12b passes into the radial set fracture site 12a and/or its engagement groove 13 in a T-shaped region.

FIG. 7 shows a partial exemplary embodiment of a connecting body 2 with a receiving opening 4. Snap-in protrusions 31 are arranged on the first ring collar 20 and can cooperate with the snap-in recesses 17 in a first snap-in region 6 (see FIGS. 3 and 4) and thus they make it possible to align the lug component 3 with respect to the connecting body 2. The contact surface 19 is used for axial positioning of the assembled connecting element 5 and thus relieves the compensating element 9.

FIG. 8 shows one exemplary embodiment of a connecting element 5 according to FIG. 2 at the time of assembly. The connecting element 5, after completion of the pre-assembly, is pressed with the assembly adapter 29 onto the connecting body 2. Thus the connecting body 2 is held by the retaining arms 18 in the retaining region 34. During the press-on step, an elastic expansion of the connecting element 5 takes place, in order subsequently to form the positive-locking, in particular enclosed perimeter snap-in connection.

FIG. 9 shows an exemplary embodiment of a connecting element 5 mounted on one side, in a partial cut-away view. The connecting element 5 is mounted to one side on the connecting body 2 and snapped in and positive-locked. The compensating element 9 features a rectangular cross section. The first contact surface 35 rests against the connecting body 2. An additional movement of the connecting element 5 in the direction of the connecting body 2, and thus a load placed on the compensating element 9 is prevented by the contact surface 19.

In this exemplary embodiment, the compensating element 9 is arranged axially offset, namely in the direction of the lug component 3 (see FIG. 1). For this reason the base body 16 of the compensating element 9 features a longer section 16b and a shorter section 16a. The longer section 16b has been pressed onto the connecting component 2 the second pressing direction A2, and snapped in to make a positive-locked connection, in that the first snap-in surface 21 cooperates with the first ring collar 20 to create the positive lock. Due to this embodiment of the connecting element 5, a preferred press-on direction is defined, so that the assembly of the connecting element 5 with the longer section 16b of the base body 16 can only be effected onto the connecting body 3.

On the inside circumference 8 of the connecting element 5 there are snap-in recesses 17 formed on the second snap-in section 7; they make it possible to define the rotation of the lug component 3 with respect to the connecting element 5. The first ring collar 20 rests under pre-tension in the first snap-in section 6. The contact surface 19 in this exemplary embodiment is oriented orthogonally to the longitudinal axis L and/or rests in a plane with the longitudinal axis L as its normal. The retaining surface 34a in this exemplary embodiment is oriented orthogonal to the longitudinal axis L and/or rests in a plane with the longitudinal axis L as its normal.

FIG. 10 shows one exemplary embodiment of a plug connector arrangement 1 in partial cut-away view. With the connecting element 5, a positive-locking connection is obtained firstly with the connecting body 2 and also with the lug component 3. In this exemplary embodiment the compensating element 9 is firmly bonded to the connecting element 5.

The lug component 3 is designed as a sensor and features a sensor channel 38 connecting the fluid channel 32 and a sensor chamber 37. The sensor channel 38 in this exemplary embodiment is sealed with a membrane 39, so that no fluid can enter from the fluid channel 32 into the sensor chamber 37. The lug component 3 designed as sensor additionally features a connecting section 40 for electrical supply and signal lines.

FIG. 11 shows one exemplary embodiment of a plug connector arrangement 1 in the assembled state. Viewed along the longitudinal axis L, the connecting element 5 features in a first edge region 41, and also in an opposite, second edge region 42, a plurality of slots 43 which are distributed uniformly along the perimeter and then proceeding from the first edge region 41 and/or the second edge region 42, extend in the direction of the snap-in regions 6, 7 and penetrate partially therein. The slots 43 each have a length that corresponds to about one-third of the height of the connecting element.

FIG. 12 shows one exemplary embodiment of a connecting element 5 according to the exemplary embodiment of FIG. 11. The slots 43 each emanate from the first edge region 41 and the second edge region 42 and extend in the direction of snap-in regions 6, 7. The first snap-in surface 21 is interrupted by the slots 43, which are distributed uniformly around the perimeter, so that the slots 43 form separate snap-in surfaces 21.

FIG. 13a shows an exemplary embodiment of a connecting element mounted on one side, and FIG. 13b depicts a cross section along line A-A according to FIG. 13a. In this exemplary embodiment, the second snap-in surface 23 of the connecting element 5 features a positioning means 44, which in this exemplary embodiment is designed as multiple trapezoidal elevations 45 which are spaced uniformly and distributed across the perimeter. The trapezoidal elevations 45 engage in the assembled state into trapezoidal setbacks 46 at the ring collar 20 of the connecting body 2, so that a tight rotational fit is obtained between the connecting element 5 and the connecting body 2 for the transfer of torque around the longitudinal axis L.

The snap-in surface 23 and the trapezoidal elevations 45—with the exception of the slanting trapezoidal surfaces—are aligned orthogonally to the longitudinal axis L. Due to the plurality of elevations 45, the angle of rotation can be adjusted in steps which correspond to the spacing of the elevations 45 around the perimeter.

FIG. 14 shows one exemplary embodiment of a connecting element 5 in partial cut-away side view. In this exemplary embodiment the compensating element 9 features a fully circular-shaped cross section. Furthermore, the first snap-in surface 21 is designed with trapezoidal elevations 45 so that a cooperation with corresponding trapezoidal setbacks 46 on the connecting body 2 (see e.g. FIG. 15) and/or on the lug component 3 is possible. In addition, in this exemplary embodiment there are snap-in recesses 17 provided, which likewise prevent any rotation.

FIG. 15 depicts one exemplary embodiment of a connecting body 2 according to the exemplary embodiment in FIG. 13a, in which the trapezoidal setbacks 46 to accommodate the trapezoidal elevations 45 of a connecting element 5 can be accommodated on the ring collar 20 according to FIG. 13a and/or according to FIG. 14. With the exception of the angled trapezoidal surfaces, the trapezoidal setbacks 46 are aligned orthogonally to the longitudinal axis, like the contact surface for the snap-in surface 23 on the connecting element 5.

FIG. 16 shows the schematic progress of a method for connecting of a connecting body 2 and of a lug component 3 of a media line, in which firstly the establishment 100 of a first positive-locking, especially a circumferentially enclosed snap-in connection is established between a connecting element 5 and a lug component 3, in that the connecting element 5 is pressed under elastic deformation at least partly onto the lug component 3, in particular onto a second ring collar 22. Next, there is the establishment 200 of a second positive-locking, in particular a circumferentially enclosed snap-in connection between the connecting element 5 and the connecting body 2, in that the connecting element 5 is pressed at least partly onto the connecting body 2, in particular onto the first ring collar 20, so that the lug component 3 is connected to the connecting body 2 by means of the connecting element 5.

The invention is not limited to the illustrated and described embodiments, but rather encompasses also all designs which are equivalent within the sense of the invention. It is expressly emphasized that the exemplary embodiments are not limited to all features in combination, rather, each individual part feature can by itself also have inventive significance even detached from all other part features. Furthermore, the invention is also not limited to the combination of features defined in claim 1, but rather can also be defined by any other particular combination of particular features of all the disclosed individual features. This means that basically virtually each individual feature of claim 1 can be omitted and/or replaced by at least one individual feature disclosed elsewhere in the application.

### LIST OF REFERENCE SYMBOLS

1 Plug connector arrangement
2 Connecting body
3 Lug component
4 Receiving opening
5 Connecting element
6 First snap-in section
7 Second snap-in section
8 Inside perimeter of the connecting element 5
9 Compensating element
10 Front surface in direction of lug component 3
11 Front surface in direction of connecting body 2
12a Set fracture site for axial separation
12b Set fracture site for radial separation
13 Engagement groove
14 Groove collar
15 Slanting insertion element
16 Base body
16a Shorter section of the base body 16
16b Longer section of the base body 16
17 Snap-in recesses
18 Retaining arms
19 Contact surface
20 First ring collar
21 First snap-in surface
22 Second ring collar
23 Second snap-in surface
24 Receiving counter-piece
25 First recess
26 Second recess
27 Third recess
28 Recess for gasket
29 Assembly adapter
30 Snap-in recess
31 Snap-in protrusions
32 Fluid channel
33 Fluid channel
34 Retaining area
34a Retaining surface
35 First contact surface
36 Second contact surface
37 Sensor area
38 Sensor channel
39 Membrane
40 Connecting section
41 First edge area
42 Second edge area
42 Slot
44 Positioning means
45 Trapezoidal-shaped elevation
46 Trapezoidal-shaped set-back
100 Establishment of the snap-in connection between 5 and 3
200 Establishment of the snap-in connection between 5 and 2

1. A plug connector arrangement for media lines, the arrangement comprising:
at least one connecting body and at least one lug component, the connecting body having at least one receiving opening for at least partial accommodating of the lug component and defining a fluid channel, the lug component being in connection with the fluid channel,
at least one connecting element connecting and retaining the connecting body and the lug component to each other the connecting element engaging the connecting body in a first positive-locking snap-in connection and the connecting element engaging the lug component in a second positive-locking snap-in connection.

2. The plug connector arrangement according to claim 1, wherein at least one of the perimeter of the first snap-in connection and the perimeter of the second snap-in connection a closed perimeter.

3. The plug connector arrangement according to c, wherein the connecting element includes at least one slot oriented parallel to a longitudinal axis defined by the connecting element.

4. The plug connector arrangement according to claim 3, wherein the at least one slot extends from at least one edge of the connecting element or that the at least one slot is disposed at a distance to at least one edge of the connecting element.

5. The plug connector arrangement according to claim 1, wherein the connecting element includes a first snap-in section and a second snap-in section, at least one of the first and second snap-in sections defining section.

6. The plug connector arrangement according to claim 1, wherein at least one of the connecting element and an inner perimeter of the connecting element is of a circular ring shape.

7. The plug connector arrangement according to claim 1, wherein the connecting element includes an elastic compensating element positioned between the connecting body and the lug component.

8. The plug connector arrangement according to claim 7, wherein the compensating element has a modulus of elasticity that is smaller than a modulus of elasticity of a base body of the connecting element, the modulus of elasticity of the base body of the connecting element being in the range between 1 GPa and 10 GPa and the modulus of elasticity of the compensating element being in the range between 0.0004 GPa and 0.1 GPa.

9. The plug connector arrangement according to claim 7, wherein the compensating element features has in axial cross section one of a polygonal shape, a trapezoidal shape, circular shape, oval shape, concave region or convex region.

10. The plug connector arrangement according to claim 7, wherein the compensating element is arranged one of centrally or offset in the axial direction relative to the connecting element.

11. The plug connector arrangement according to claim 1, wherein the connecting element and compensating element is provided at least in part with a polytetrafluoroethylene (PTFE) coating.

12. The plug connector arrangement according to claim 1, wherein the connecting element includes at least two set fracture sites configured to irreversibly separate in one of a radial or axial direction.

13. The plug connector arrangement according to claim 12, wherein the set fracture sites include at least one tool engagement groove and collar defined on an outer perimeter of the connecting element.

14. The plug connector arrangement according to claim 1, wherein the connecting element includes along an inner perimeter at least one of a snap-in recess or one snap-in protrusion defining an angle of rotation between connecting element and at least one of the lug component and the connecting body.

15. The plug connector arrangement according to claim 1, wherein the connecting element includes at least one first snap-in surface and at least one second snap-in surface, at least one positioning means provided on at least one of the first snap-in surface and the second snap-in surface and defining an angle of rotation between connecting element and one of the lug component and the connecting body.

16. The plug connector arrangement according to claim 1, wherein the connecting element is retained by a radial pre-tensioning force applied against one of a first ring collar on the connecting body or a second ring collar on the lug component.

17. The plug connector arrangement according to claim 1, wherein the connecting body includes at least one contact surface engaged with the connecting element.

18. The plug connector arrangement according to claim 1, wherein the connecting body includes a retaining area having at least one retaining surface configured to receive radially insertable retaining arms of an assembly tool.

19. A connecting element for a plug connector arrangement according to claim 3.

20. A method for establishing a plug connector arrangement with a connecting body and a lug component of a media line according to claim 1, the method comprising the following steps:
establishing a first positive-locking snap-in connection between the connecting element and the lug component by pressing the connecting element in a first pressing direction and at least partly onto the lug component,
establishing a second positive-locking snap-in connection between the connecting element and the connecting body by pressing the connecting element in a second pressing direction and at least partly onto the connecting body,
wherein the lug component is connected to the connecting body by the connecting element.

21. The method according to claim 20, wherein the first positive-locking snap-in connection and the second positive-locking snap-in connection are formed under elastic deformation of the connecting element with an elastic deformation of between 6% and 7%.

22. The method according to claim 20, wherein one of the first snap-in connection and the second snap-in connection are closed about the perimeter.

23. The method according to claim 20, wherein during one of the steps of establishing the first positive-locking snap-in connection or the second positive-locking snap-in connection, a pressing force is applied directly onto a front surface of the connecting element.

24. The method according to claim 23, wherein during the establishing of the second positive-locking snap-in connection, the connecting component is held by two radially inserted retaining arms and a pressing force is applied by an assembly adapter onto a front surface of the connecting element.
